(19) United States
(12) Patent Application Publication
(10) Pub. No.: US 2024/0418977 A1
(43) Pub. Date: Dec. 19, 2024

(54) MICROSCOPE OBJECTIVE LENS SWITCHING APPARATUS, AND MICROSCOPE

(71) Applicant: AAC Microtech (Changzhou) Co., Ltd., Changzhou (CN)

(72) Inventors: Xingyu Li, Changzhou (CN); Rui Zhang, Changzhou (CN); Jin Hu, Changzhou (CN); Xueyuan Zhu, Changzhou (CN)

(21) Appl. No.: 18/399,805

(22) Filed: Dec. 29, 2023

Related U.S. Application Data
(63) Continuation of application No. PCT/CN2023/101054, filed on Jun. 19, 2023.

(51) Int. Cl. G02B 21/24

(52) U.S. Cl. CPC G02B 21/248

(57) ABSTRACT

The switching apparatus, configured to switch an objective lens of a microscope, includes a base, a rotation drive module secured onto the base, a transmission module connected to the rotation drive module, and a turntable fixedly connected to the transmission module and the objective lens. The transmission module includes a housing fixed onto the base, a coupler with one end detachably secured to an output shaft of the rotation drive module, a double lead worm fixedly connected to another end of the coupler, and a worm gear in mesh engagement with the double lead worm. The worm gear is fixedly connected to the turntable, and by disconnecting the coupler from the output shaft and rotating the coupler, the double lead worm moves along an axial direction to change a mesh engagement clearance between the double lead worm and the worm gear.

### CROSS REFERENCE TO RELATED APPLICATIONS

This application is a continuation of PCT Patent Application No. PCT/CN2023/101054, filed Jun. 19, 2023, which is incorporated by reference herein in its entirety.

### TECHNICAL FIELD

The present disclosure relates to the technical field of microscopes, and in particular, relates to a microscope objective lens switching apparatus, and a microscope.

### BACKGROUND

A microscope possesses a remarkable magnification ability, and typically includes multiple objective lenses. Different combinations of these lenses are switched according to specific needs to achieve different levels of magnification. Due to a substantial magnification, even minor deviations may cause significant image shifts. Therefore, a high-precision objective lens switching apparatus is desired. At present, there are two primary structures for objective lens switching apparatuses available in the market. One is a worm gear transmission mechanism with non-adjustable precision. This mechanism lacks high accuracy, especially as wear and tear over time can lead to decreased meshing and reduced precision. The other is a gear-driven mechanism with mechanical structure-based limitations. This mechanism offers high precision, but its critical components are prone to damage over extended use and need to be periodically replaced.

Therefore, it is desired to provide a microscope objective lens switching apparatus and a microscope to satisfy the needs of high precision and long lifetime.

### SUMMARY

The embodiments of the present disclosure are intended to provide a microscope objective lens switching apparatus and a microscope to satisfy the needs of high precision and long lifetime.

An embodiments of the present disclosure provides a microscope objective lens switching apparatus configured to switch an objective lens of a microscope. The switching apparatus includes a base, a rotation drive module secured onto the base, a transmission module connected to the rotation drive module, and a turntable fixedly connected to the transmission module and fixedly connected to the objective lens.

The transmission module includes a housing fixed onto the base, a coupler with one end detachably secured to an output shaft of the rotation drive module, a double lead worm fixedly connected to another end of the coupler, and a worm gear in mesh engagement with the double lead worm. The worm gear is fixedly connected to the turntable, and by disconnecting the coupler from the output shaft and rotating the coupler, the double lead worm moves along an axial direction to change a mesh engagement clearance between the double lead worm and the worm gear.

As an improvement, a thickness of the double lead worm decreases from a side close to the coupler to a side away from the coupler, and the double lead worm has identical flank leads on the side away from the coupler.

As an improvement, one end of the coupler is threaded to the output shaft.

As an improvement, the switching apparatus further includes a manual knob arranged on a side, away from the rotation drive module, of the housing, and the manual knob is threaded to one end, away from the coupler, of the double lead worm.

As an improvement, a first threaded hole in threaded engagement with one end, away from the coupler, of the double lead worm, and a second threaded hole in communication with the first threaded hole are defined in the manual knob, and a stop screw passing through the second threaded hole and configured to secure the double lead worm is connected to the second threaded hole.

As an improvement, the transmission module further includes a first bearing arranged on a side, facing towards the double lead worm, of the manual knob, a bearing sleeve fixedly connected to an inner side of the first bearing, and a flat key slidably connected to the bearing sleeve, and a keyway corresponding to the flat key defined in the double lead worm, and a slideway axially parallel to the double lead worm are defined in an inner side of the bearing sleeve. One side of the flat key is embedded into the keyway, another side of the flat key is situated in the slideway, a length of the slideway in the axial direction of the double lead worm is greater than a length of the flat key, a width of the slideway and a width of the keyway are equal to a width of the flat key, and the manual knob is threaded to the bearing sleeve.

As an improvement, the transmission module further includes a second bearing sleeved onto a side, close to the coupler, of the double lead worm, and a clamping spring sleeved onto the double lead worm and situated on a side, close to the coupler, of the second bearing, an outer side of the second bearing is detachably and fixedly connected to the housing, and the clamping spring is configured to restrict an axial movement of the second bearing along the double lead worm.

As an improvement, a plurality of first connection holes are defined in the turntable, and are configured to connect the objective lens.

As an improvement, a plurality of second connection holes are defined in the base, and are configured to connect an ocular lens system of the microscope.

An embodiment of the present disclosure further provides a microscope. The microscope includes the microscope objective lens switching apparatus as described above.

The embodiments of the present disclosure achieve the following beneficial effects. The microscope objective lens switching apparatus according to the embodiments of the present disclosure utilizes the rotation drive module to adjust the turntable for objective lens switching, thereby achieving high adjustment precision, and employs the structure involving the double lead worm and the worm gear, thereby allowing rapid adjustment of the mesh engagement clearance between the double lead worm and the worm gear with no need of component replacement. In this way, the precision is quickly adjusted when the switching precision is degraded, such that the lifetime is greatly prolonged.

### BRIEF DESCRIPTION OF THE DRAWINGS

FIG. 1 is a schematic diagram illustrating a structure from a first perspective of a microscope objective lens switching apparatus in accordance with some embodiments;

FIG. 2 is a schematic diagram illustrating a structure from a second perspective of a microscope objective lens switching apparatus in accordance with some embodiments;

FIG. 3 is a schematic diagram illustrating a structure from a third perspective of a microscope objective lens switching apparatus in accordance with some embodiments;

FIG. 4 is a sectional view of the structure in FIG. 3 taken along an A-A′ line; and

FIG. 5 is a partial enlarged view of part B in FIG. 4.

### DETAILED DESCRIPTION OF THE EMBODIMENTS

The present disclosure is further described with reference to and the attached drawings and specific embodiments.

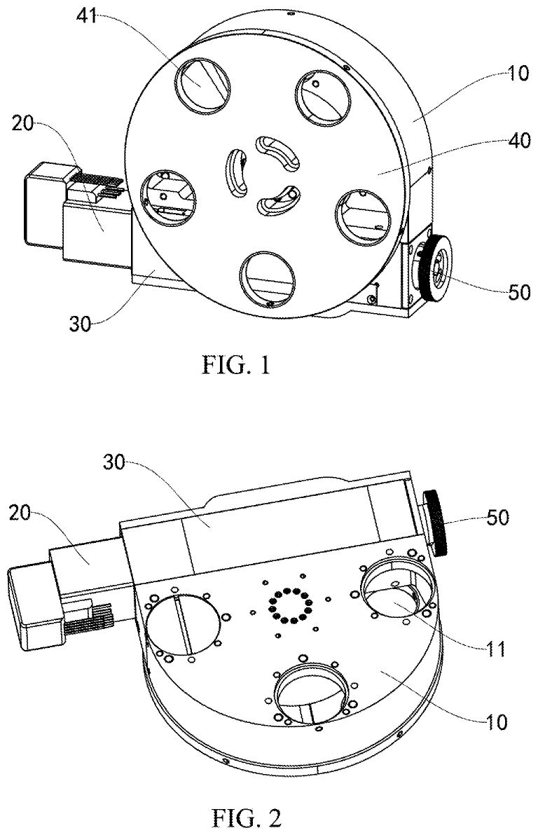

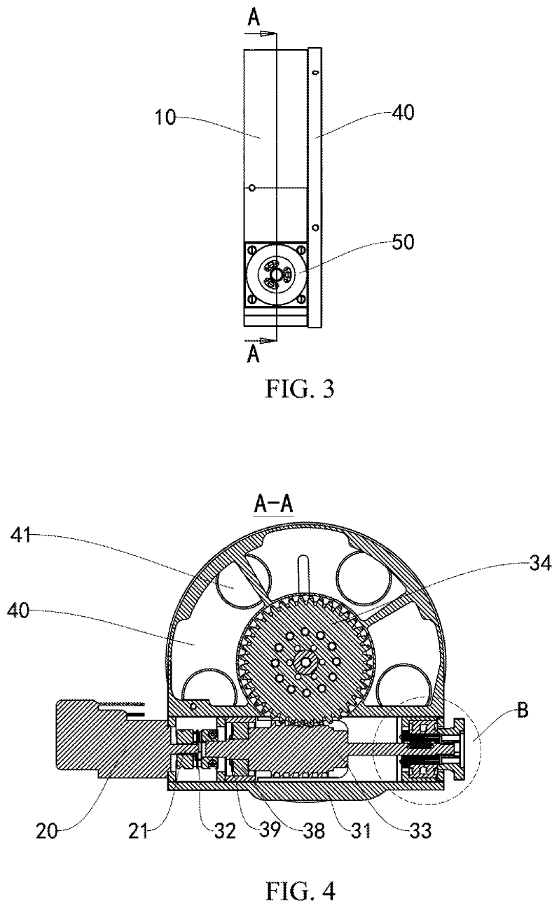

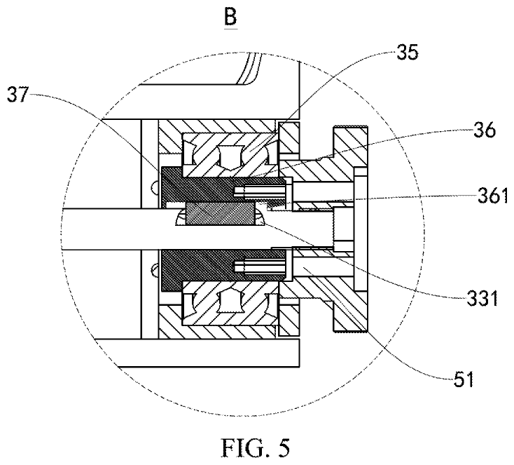

As illustrated in FIG. 1 to FIG. 5, a microscope objective lens switching apparatus according to an embodiment of the present disclosure is configured to switching an objective lens of a microscope. The switching apparatus includes a base 10, a rotation drive module 20, a transmission module 30, and a turntable 40.

The base 10 is configured to connect an ocular lens system of the microscope. The rotation drive module 20 is secured onto the base 10, and is connected to the transmission module 30. The rotation drive module 20 is configured to drive the transmission module 30. The transmission module 30 is fixedly connected to the turntable 40. The turntable 40 is fixedly connected to an objective lens. In the embodiments, the rotation drive module 20 is a stepper motor. During operation, the rotation drive module 20 drives, via the transmission module 30, the turntable 40 to rotate, and the turntable 40 drives the objective lens to rotate in order to switch the objective lens.

Specifically, the transmission module 30 includes a housing 31, a coupler 32, a double lead worm 33, and a worm gear 34. The housing 31 is secured onto the base 10. One end of the coupler 32 is detachably and fixedly connected to an output shaft 21 of the rotation drive module 20, specifically, threaded to the output shaft 21 via screws. Another end of the coupler 32 is fixedly connected to the double lead worm 33. The worm gear 34 is in mesh engagement with the double lead worm 33, and the worm gear 34 is fixedly connected to the turntable 40.

The principles of objective lens switching are as follows: The rotation drive module 20 is rotated to drive the double lead worm 33 to rotate, and the double lead worm 33 drives the worm gear 34 to rotate in order to finally drive the turntable 40 to rotate.

The microscope objective lens switching apparatus according to the embodiment of the present disclosure allows for quick precision adjustments. When the mesh engagement clearance between the double lead worm 33 and the worm gear 34 is excessive, the switching precision of the microscope objective lens switching apparatus decreases. In this case, adjusting the mesh engagement clearance between the double lead worm 33 and the worm gear 34 becomes a necessity to promptly improve the switching accuracy. The adjustment principle is as follows: The coupler 32 is disconnected from the output shaft 21 specifically by loosening the screws connecting the coupler 32 to the output shaft 21; the coupler 32 is rotated such that the coupler 32 drives the double lead worm 33 to axially move together to change the mesh engagement clearance between the double-lead worm 33 and the worm gear 34 until the coupler 32 has no margin to rotate; this indicates that the mesh engagement clearance between the double-lead worm 33 and the worm gear 34 is close to zero; and in this case, the switching accuracy of the microscope objective lens switching apparatus reaches a highest level; and finally, the coupling 32 is fixedly re-connected to the output shaft 21, thereby completing the adjustment.

The microscope objective lens switching apparatus according to the embodiment of the present disclosure utilizes the rotation drive module 20 to adjust the turntable 40 for objective lens switching, thereby achieving high adjustment precision; and employs the structure involving the double lead worm 33 and the worm gear 34, thereby allowing rapid adjustment of the mesh engagement clearance between the double lead worm 33 and the worm gear 34 with no need of component replacement. In this way, the precision is quickly adjusted when the switching precision is degraded, such that the lifetime is greatly prolonged.

Furthermore, a thickness of the double lead worm 33 progressively decreases from a side close to the coupler 32 to a side away from the coupler 32, the double lead worm 33 has identical flank leads on the side away from the coupler 32, and the worm gear 34 has a uniform gear thickness.

Furthermore, the switching apparatus further includes a manual knob 50 arranged on a side, away from the rotation drive module 20, of the housing 31. The manual knob 50 is threaded to one end, away from the coupler 32, of the double lead worm 33. By configuration of the manual knob 50, the flexibility of the microscope objective lens switching apparatus is further improved. Specifically, a first threaded hole 51 in threaded engagement with one end, away from the coupler 32, of the double lead worm 33, and a second threaded hole (not shown in figure) in communication with the first threaded hole 51 are defined in the manual knob 50. A stop screw (not shown in figure) passing through the second threaded hole and configured to secure the double lead worm 33 is connected to the second threaded hole. During normal use, the stop screw tightly secures the part, inserted into the first thread hole 51, of the double lead worm 33, such that double securing is achieved and loosening is prevented. Prior to precision adjustment, the stop screw is loosened, and a length of the portion, inserted into the first threaded hole 51, of the double lead worm 33 may change, such that precision adjustment is implemented, and afterwards, the stop screw is locked.

Furthermore, the transmission module 30 further includes a first bearing 35 arranged on a side, facing towards the double lead worm 33, of the manual knob 50, a bearing sleeve 36 fixedly connected to an inner side of the first bearing 35, and a flat key 37 slidably connected to the bearing sleeve 36. A keyway 331 corresponding to the flat key 37 defined in the double lead worm 33, and a slideway 361 axially parallel to the double lead worm 33 is defined in an inner side of the bearing sleeve 36. One side of the flat key 37 is embedded into the keyway 331, and another side of the flat key 37 is situated in the slideway 361. A length of the slideway 361 in the axial direction of the double lead worm 33 is greater than a length of the flat key 37. A width of the slideway 361 and a width of the keyway 331 are equal to a width of the flat key 37. The manual knob 50 is threaded to the bearing sleeve 36. During normal use, the double lead worm 33, the flat key 37, the bearing sleeve 36, the manual knob 50 may not be subject to relative movement, but may rotate together along an axis of the double lead worm 33. The first bearing 35 is an angular contact bearing. Prior to precision adjustment, the stop screw needs to be loosened, the manual knob 50 needs to be disconnected from the bearing sleeve 36, and the coupler 32 needs to be disconnected from the output shaft 21; the coupler 32 is rotated such that the coupler 32 drives the double lead worm 33 to move together along the axial direction, and the double lead worm 33 drives the flat key 37 to slide along the slideway 361, specifically, sliding along a lengthwise direction of the slideway 361; the bearing sleeve 36 and the first bearing 35 are only rotatably moved but not axially moved until the coupler 32 has no margin to rotate; this indicates that the mesh engagement clearance between the double-lead worm 33 and the worm gear 34 is close to zero; in this case, the switching accuracy of the microscope objective lens switching apparatus reaches a highest level; and the coupler 32 is fixedly re-connected to the output shaft 21, the manual knob 50 is fixedly re-connected to the bearing sleeve 36, and the stop screw is re-tightened, thereby completing the adjustment.

Furthermore, the transmission module 30 further includes a second bearing 38 sleeved onto a side, close to the coupler 32, of the double lead worm 33, and a clamping spring 39 sleeved onto the double lead worm 33 and situated on a side, close to the coupler 32, of the second bearing 38. An outer side of the second bearing 38 is detachably and fixedly connected to the housing 31, specifically by screws. The clamping spring 39 is configured to restrict an axial movement of the second bearing 38 along the double lead worm 33. Prior to precision adjustment, the second bearing 38 also needs to be disconnected from the housing 31, such that the second bearing 38 and the double lead worm 33 are rotated together along an axial direction. Upon precision adjustment, the second bearing 38 is re-secured to the housing 31. The second bearing 38 is a deep groove ball bearing.

Furthermore, a plurality of first connection holes 41 are defined in the turntable 40, and is configured to connect the objective lens. In this embodiment, five first connection holes 41 are arranged, and the number of first connection holes 41 may also be defined to other values, for example, three, four, or the like.

Furthermore, a plurality of second connection holes 11 are defined in the base 10. The second connection holes 11 is configured to connect the ocular lens system of the microscope. In this embodiment, three second connection holes 11 are arranged, and the number of second connection holes 11 may also be defined to other values, for example, two, four, or the like.

An embodiment of the present disclosure further provides a microscope. The microscope includes the microscope objective lens switching apparatus as described above.

Described above are merely exemplary embodiments of the present disclosure. It should be noted that persons of ordinary skill in the art would make various improvements without departing from the inventive concept of the present disclosure, and such improvements shall fall within the protection scope of the present disclosure.

What is claimed is:

1. A microscope objective lens switching apparatus configured to switch an objective lens of a microscope, the switching apparatus comprising: a base, a rotation drive module secured onto the base, a transmission module connected to the rotation drive module, and a turntable fixedly connected to the transmission module and fixedly connected to the objective lens;
wherein the transmission module comprises a housing fixed onto the base, a coupler with one end detachably secured to the an output shaft of the rotation drive module, a double lead worm fixedly connected to another end of the coupler, and a worm gear in mesh engagement with the double lead worm, wherein the worm is fixedly connected to the turntable, and by disconnecting the coupler from the output shaft and rotating the coupler, the double lead worm moves along an axial direction to change a mesh engagement clearance between the double lead worm and the worm gear.

2. The microscope objective lens switching apparatus according to claim 1, wherein a thickness of the double lead worm decreases from a side close to the coupler to a side away from the coupler, and the double lead worm has identical flank leads on the side away from the coupler.

3. The microscope objective lens switching apparatus according to claim 1, wherein one end of the coupler is threaded to the output shaft.

4. The microscope objective lens switching apparatus according to claim 1, further comprising: a manual knob arranged on a side, away from the rotation drive module, of the housing, wherein the manual knob is threaded to one end, away from the coupler, of the double lead worm.

5. The microscope objective lens switching apparatus according to claim 4, wherein a first threaded hole in threaded engagement with one end, away from the coupler, of the double lead worm, and a second threaded hole in communication with the first threaded hole are defined in the manual knob, wherein a stop screw passing through the second threaded hole and configured to secure the double lead worm is connected to the second threaded hole.

6. The microscope objective lens switching apparatus according to claim 4, wherein the transmission module further comprises a first bearing arranged on a side, facing towards the double lead worm, of the manual knob, a bearing sleeve fixedly connected to an inner side of the first bearing, and a flat key slidably connected to the bearing sleeve, wherein a keyway corresponding to the flat key defined in the double lead worm, and a slideway axially parallel to the double lead worm is defined in an inner side of the bearing sleeve, wherein one side of the flat key is embedded into the keyway, another side of the flat key is situated in the slideway, a length of the slideway in the axial direction of the double lead worm is greater than a length of the flat key, a width of the slideway and a width of the keyway are equal to a width of the flat key, and the manual knob is threaded to the bearing sleeve.

7. The microscope objective lens switching apparatus according to claim 1, wherein the transmission module further comprises a second bearing sleeved onto a side, close to the coupler, of the double lead worm, and a clamping spring sleeved onto the double lead worm and situated on a side, close to the coupler, of the second bearing, wherein an outer side of the second bearing is detachably and fixedly connected to the housing, and the clamping spring is configured to restrict an axial movement of the second bearing along the double lead worm.

8. The microscope objective lens switching apparatus according to claim 1, wherein a plurality of first connection holes are defined in the turntable, wherein the plurality of first connection holes are configured to connect the objective lens.

9. The microscope objective lens switching apparatus according to claim 1, wherein a plurality of second connection holes are defined in the base, wherein the plurality of second connection hole are configured to connect an ocular lens system of the microscope.

10. A microscope, comprising: a microscope objective lens switching apparatus, configured to switch an objective lens of the microscope;
the switching apparatus comprising: a base, a rotation drive module secured onto the base, a transmission module connected to the rotation drive module, and a turntable fixedly connected to the transmission module and fixedly connected to the objective lens;
wherein the transmission module comprises a housing fixed onto the base, a coupler with one end detachably secured to the an output shaft of the rotation drive module, a double lead worm fixedly connected to another end of the coupler, and a worm gear in mesh engagement with the double lead worm, wherein the worm is fixedly connected to the turntable, and by disconnecting the coupler from the output shaft and rotating the coupler, the double lead worm moves along an axial direction to change a mesh engagement clearance between the double lead worm and the worm gear.
